(19) United States
(12) Patent Application Publication
(10) Pub. No.: US 2003/0156328 A1
(43) Pub. Date: Aug. 21, 2003

(54) Light guide plate and surface light source device utilizing same

(75) Inventors: Youichiro Goto, Gifu (JP); Toru Nose, Gifu (JP)

Correspondence Address: ARENT FOX KINTNER PLOTKIN & KAHN, PLLC, Suite 600, 1050 Connecticut Avenue, N.W., Washington, DC, 20036-5339, US

(73) Assignee: SANYO ELECTRIC CO., LTD

(21) Appl. No.: 10/365,505

(22) Filed: Feb. 13, 2003

(30) Foreign Application Priority Data
Feb. 15, 2002 (JP) 2002-038986

(51) Int. Cl. G02B 23/00; G02B 5/02; G02B 13/20; G02B 5/04; G02B 7/18

(52) U.S. Cl. 359/599; 359/431; 359/831

(57) ABSTRACT

A surface light source device includes a light guide plate. A light beam generated from a point light source is irradiated from a corner portion formed at a side surface of the light guide plate. The irradiated light beam is emitted from an upper surface on which prisms are formed. The prisms extend in a circular arc form so as to connect two side surfaces forming the corner portion.

### BACKGROUND OF THE INVENTION

1. Field of the Invention

The present invention relates to a light guide plate and a surface light source device. More specifically, the present invention relates to a light guide plate and a surface light source device utilizing the same for emitting from one main surface a light beam irradiated from a corner portion formed by a first side surface and a second side surface.

2. Description of the Prior Art

One example of conventional such a kind of light guide plate is disclosed in Japanese Patent Laying-open No. 10-255530 laid-open on Sep. 25, 1998. In the prior art, the light guide plate is formed with an incidence surface at a corner and dispersion pattern elements on a lower surface thereof, and whereby, it is possible to make a surface lighting by use of a point light source.

However, the dispersion pattern elements are arranged at random so as to become higher in density with being away from the point light source. The light guide plate can be obtained by an injection molding utilizing a metal mold made by a master. For manufacturing such the dispersion pattern elements on the master, a manufacturing process similar to that of a semiconductor device is generally required. Specifically, in order to manufacturing the master, it is required that a mask pattern of a photoresist is created on a glass substrate surface, a concave portion is created by an etching process and a plating process is performed on a pattern surface including the concave portion so as to become conductive. A mask pattern element surface thus obtained is subjected to an electroplating process (thick plating process) and then, the electroplating portion is delaminated and whereby, a stamping die can be obtained. That is, the electroplating portion becomes the stamping die utilized for the injection molding.

However, the mirror finish is difficult for the etching, and therefore, it is impossible to satisfactorily diffuse the light beam on the dispersion pattern elements formed on the master or the light guide plate. That is, in prior art, a luminance characteristic is not enough on an emission surface of the light guide plate.

### SUMMARY OF THE INVENTION

Therefore, it is a primary object of the present invention to provide a light guide plate or a surface light source device capable of improving a luminance characteristic on an emission surface.

A light guide plate according to the present invention comprises: a corner portion formed by a first side surface and a second side surface; and one main surface for emitting a light beam irradiated from the corner portion, wherein the one main surface is formed with a prism extending in circular arc form with rendering the corner portion as a center so as to connect the first side surface and the second side surface.

The light beam is irradiated from the corner portion formed by the first side surface and the second side surface and emitted from the one main surface. The one main surface is formed with the prism in a circular arc form rendering the corner portion as a center point so as to connect the first side surface and the second side surface.

Because of forming the prism in the circular arc form, a master for manufacturing the light guide plate can be obtained by performing a cutting on one main surface of a master substrate. Thus, it is easy to perform a mirror finish of the prisms and therefore, it is possible to improve a luminance characteristic on an emission surface.

Where a height of the prism is changed in the longitudinal direction, it is possible to flexibly control a luminance distribution in the longitudinal direction. Herein, where the height of the prisms is changed so as to become the lowest at an intersection with the central axis of the light beam irradiated from the corner portion, the luminance distribution of the prism in the longitudinal direction can be freely made uniform.

Where a plurality of prisms are formed on the one main surface, and the heights of the respective prisms are made different from each other in a direction away from the corner portion, it is possible to flexibly control the luminance distribution in the direction. Herein, where the heights of the respective prisms are made higher with being away from the corner portion, it is possible to make the luminance distribution uniform irrespective of distances from the corner portion.

The above described objects and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an illustrative view showing a configuration of one embodiment of the present invention;

FIG. 2 is an illustrative view showing a sectional form of a light guide plate applied to FIG. 1 embodiment (sectional form of prisms in a longitudinal direction);

FIG. 3 is a graph showing a change of the heights of the prisms in a central axis L1 direction of FIG. 1 embodiment;

FIG. 4 is a graph showing changes of the heights of the prisms in the longitudinal direction of the FIG. 1 embodiment;

FIG. 5 is an illustrative view showing a configuration of another embodiment of the present invention;

FIG. 6 is a graph showing a change of the heights of the prisms in a central axis L1 direction of FIG. 5 embodiment;

FIG. 7 is a graph showing changes of the heights of the prisms in the longitudinal direction of FIG. 5 embodiment; and

FIG. 8 is an illustrative view showing a sectional form of the light guide plate (sectional form of the prism in the longitudinal direction) applied to another embodiment of the present invention.

### DETAILED DESCRIPTION OF THE PREFERRED EMBODIMENTS

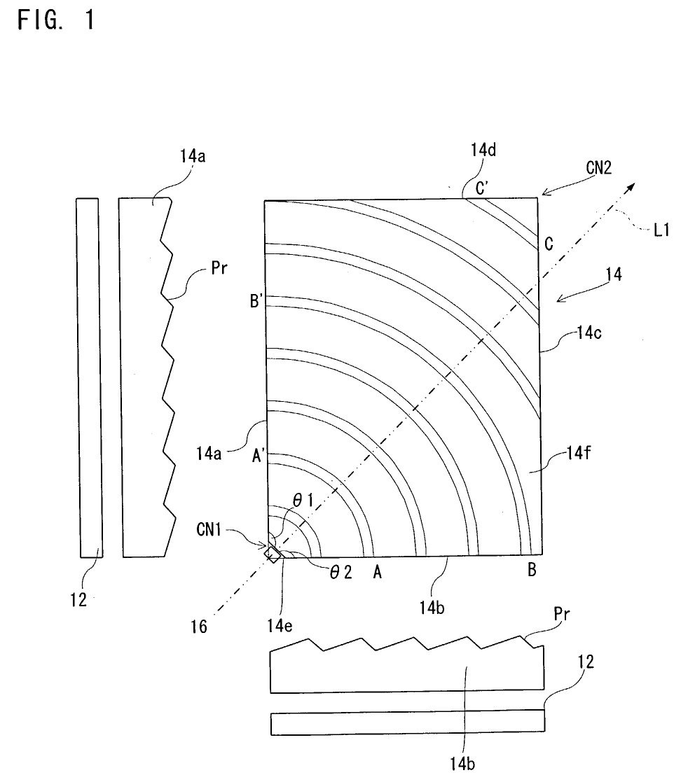

Referring to FIG. 1, a liquid crystal display device 10 of the embodiment includes a plate-shaped liquid crystal panel unit 12, a light guide plate 14 placed on an upper surface of the liquid crystal panel unit 12 and a point light source 16 place at the same height as the light guide plate 14.

Herein, the liquid crystal panel unit 12 is a reflective type panel unit. Although not shown in detail in the drawing, a light reflector, a liquid crystal layer, a color filter, a glass plate and a deflecting plate are laminated on a glass substrate in this order.

The light guide plate 14 is a rectangular parallelepiped-shaped plate made of acrylic resin. A corner portion CN1 formed by a side surface 14a and a side surface 14b which are orthogonal to each other is formed with an incidence surface 14e. Angles θ1 and θ2 which are respectively formed by the incidence surface 14e and the side surfaces 14a and 14b are 135°. The light guide plate 14 has a large number of prisms Pr, Pr, . . . extending in circular arc form rendering the corner portion CN1 as the center on an upper surface 14f. It is noted that a corner portion between side surfaces 14c and 14d is defined as “CN2”.

A light emitting diode is utilized as the point light source 16. The point light source 16 is placed near the incidence surface 14e such that a central axis L1 of the emission light is orthogonal to the incidence surface 14e at the center thereof.

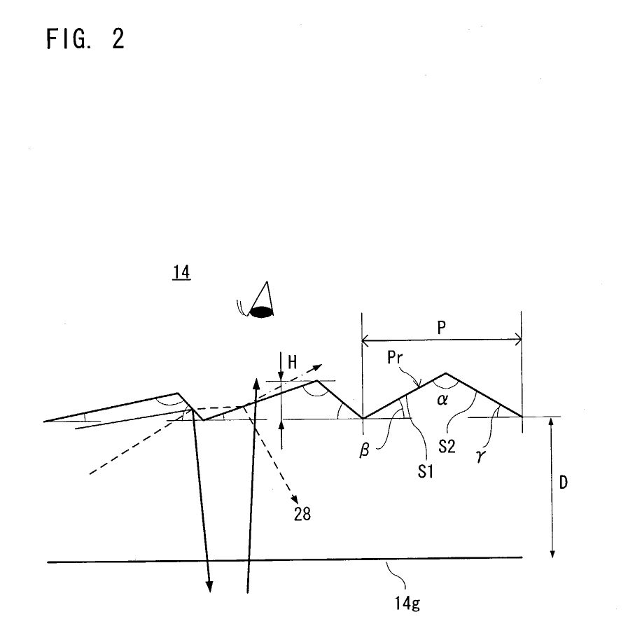

Referring to FIG. 2, each prism Pr in the longitudinal direction has cross-section in a mountain-shape which is formed by slants S1 and S2. Two adjacent prisms Pr are connected by the slant S1 of one prism Pr and the slant S2 of the other prism Pr. The light beam received from the incidence surface 14e is directly irradiated onto the slant S2. If the incidence angle of the light beam to the slant S2 is equal to or more than a critical angle, the entire light beam is reflected by the slant S2. On the other hand, the incidence angle to the slant S2 is less than the critical angle, a part of the light beam is reflected by the slant S2, and the rest is emitted from the slant S2 to the outside. It is noted that when the light beam emitted from the slant S2 is irradiated onto the slant S1, a part of the light beam is returned to the light-guide plate 14 in accordance with a relation between the incident angle and the critical angle.

The light beam reflected by the slant S2 and the light beam returned from the slant S1 to the inside are emitted from a lower surface 14g of the light guide plate 14. The emitted light is irradiated onto the liquid crystal panel unit 12 and passes through the above-described liquid crystal layer and etc., reflected by the light reflector toward the upper direction and then, passes through the liquid crystal layer again. The light passes through the liquid crystal layer is emitted from an upper surface 14f to the upper direction through the light guide plate 14.

A pitch P and an apex angle a of each of prisms Pr are uniform, and a distance D from a tangent between two adjacent prisms Pr to the lower surface 14g is also uniform. It is noted that a height H of each prism Pr or an area of the slant S2 becomes larger with being away from the point light source 16. Accordingly, an angle β formed by the slant S1 and the lower surface 14g becomes larger with being away from the point light source 16, and an angle γ formed by the slant S2 and the lower surface 14g becomes smaller with being away from the point light source 16. Furthermore, paying attention to each prism Pr in the longitudinal direction, the height H is the tallest at the ends of the prism in the longitudinal direction and is the smallest at the center of the prism in the longitudinal direction.

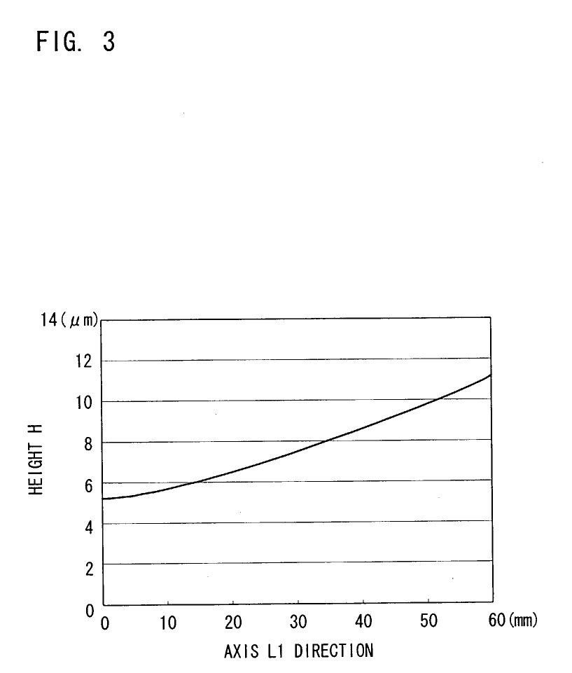

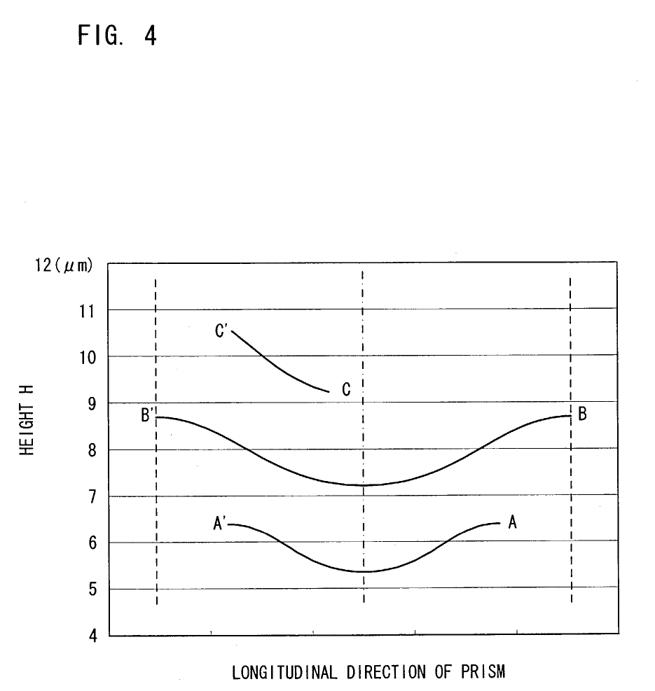

The height H is specifically changed as shown in FIG. 3 and FIG. 4. FIG. 3 is a graph showing a change of the heights H in the above-described central axis L1 direction, and coordinates become larger toward an arrow direction from the incidence surface 14e. According to FIG. 3, the height H renders a gradual quadratic curve. Furthermore, FIG. 4 shows changes of the heights H of the prisms Pr connected between A-A′, between B-B′ and between C-C′ shown in FIG. 1 in the longitudinal direction. It is apparent from the graph that the height H of each prism Pr renders a curve so as to become the lowest at an intersection with the central axis L1.

An amount of the light beam emitted from the point light source 16 decreases with being away from the incidence surface 14e, and therefore, the height H of each prism Pr is made larger with being away from the central axis L1. Thus, it is possible to render the light amount irradiated to each slope S2 uniform. Furthermore, because of a difference of a reflactive index between air and the light guide plate 14 (air: 1, light guide plate: 1.49), the incident light from the incidence surface 14e tends to concentrate in the central axis L1. This is the reason why the height H of the prism Pr in the longitudinal direction at the center is made lower than that at the ends, and a light amount irradiated on the slope S2 is made uniform in the longitudinal direction of the prism Pr also. That is, according to this embodiment, it is possible to make a luminance distribution uniform on the upper surface 14f and the lower surface 14g.

A master for manufacturing the light guide plate 14 having such a structure can be obtained by forming a prism Prm having the same form as the prism Pr on an upper surface of a master substrate by cutting. The prism Pr, i.e., Prm is a prism extending in a circular arc form, so that it becomes possible to perform the cutting and it becomes easy to perform a mirror finish. Thus, it is possible to improve the luminance characteristic of the light beam emitted from the upper surface 14f or the lower surface 14g.

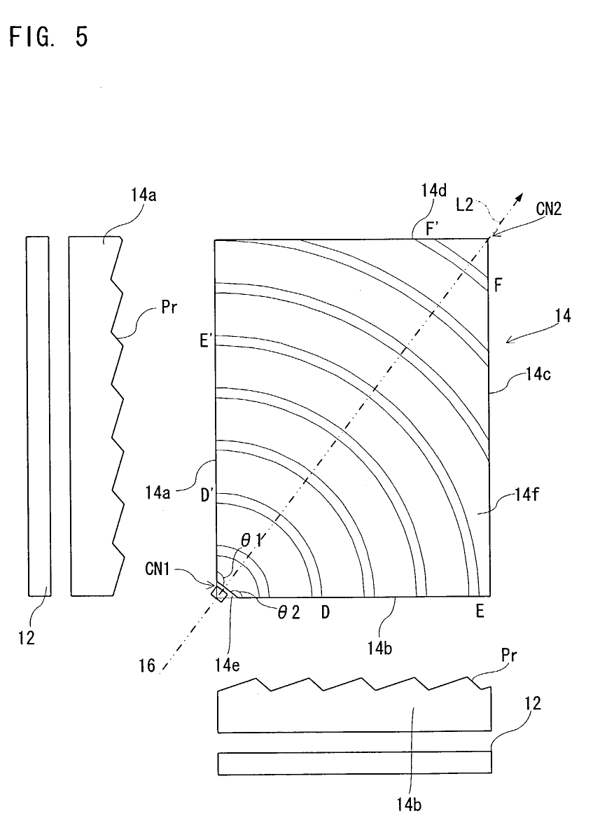

Referring to FIG. 5, the liquid crystal display device 10 of another embodiment is approximately the same as the FIG. 1 embodiment, and therefore, a description is concentrated on a different part and a duplicate description is omitted as to a common part.

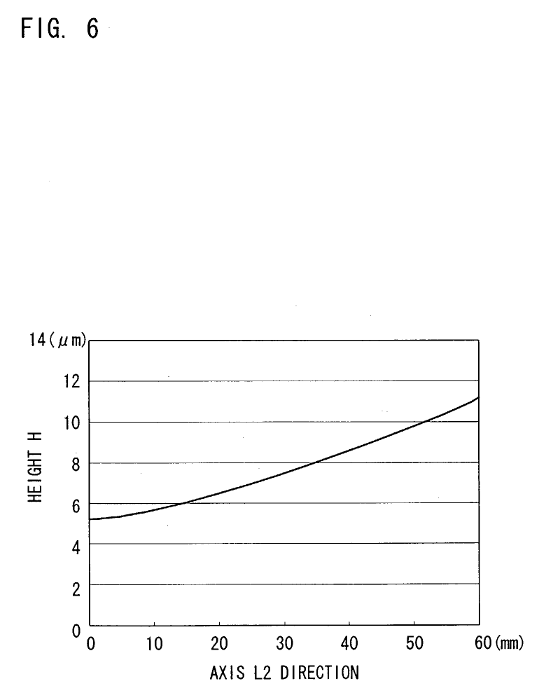

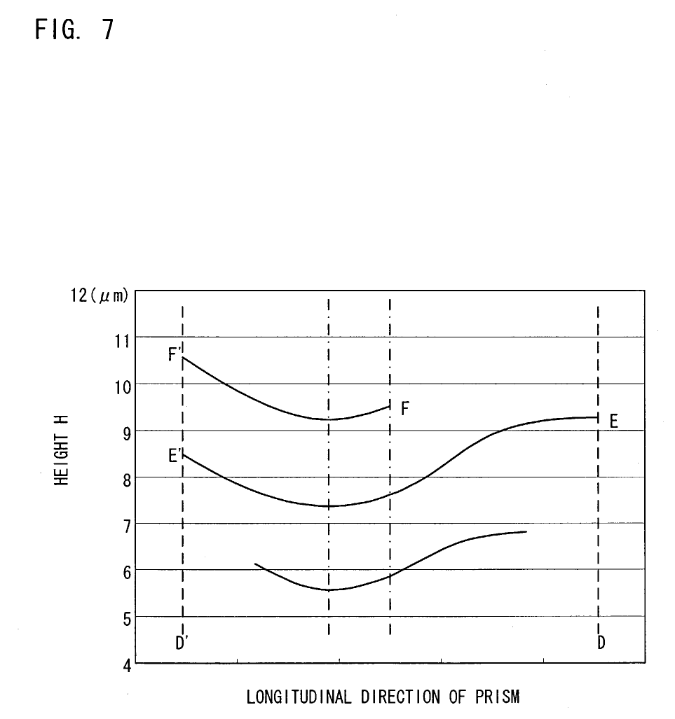

The point light source 16 is placed near the incidence surface 14e such that the central axis L2 of the emitted light connects the corner portions CN1 and CN2 of the light guide plate 14. Furthermore, the incidence surface 14e is formed so as to be orthogonal to the central axis L2. In addition, the height H of each prism Pr changes as shown in FIG. 6 and FIG. 7.

FIG. 6 is a graph showing a change of the heights H of the prisms Pr in the central axis L2 direction, and the coordinates becomes larger toward an arrow direction from the incidence surface 14e. In FIG. 6 also, the height H renders a gradual quadratic curve. Furthermore, FIG. 7 shows changes of the heights H of the prisms Pr connected between D-D′, between E-E′ and between F-F′ in the longitudinal direction. It is apparent from the graph that the height H of each prism Pr renders a curve so as to become the lowest at an intersection with the central axis L2. In this embodiment also, it is possible to make the luminance distribution uniform on the upper surface 14f and the lower surface 14g.

Noted that it is needless to say that a master for manufacturing the light guide plate 14 of this embodiment is obtained in the same manner as the FIG. 1 embodiment.

The prisms Pr in the FIG. 1 embodiment and the FIG. 5 embodiment are formed by two slopes S1 and S2 shown in FIG. 2, and either the angle β formed by the slope S1 and the lower surface or the angle γ formed by the slope S2 and the lower surface is an acute angle. Therefore, the light beam emitted from the upper surface 14f without passing through the liquid crystal panel unit 12 is never directed to a direction orthogonal to the upper surface 14f or the lower surface 14g. Thus, it is possible to prevent a contrast of a displayed image from decreasing.

It is noted that the prism Pr is formed such that the height H is changed in the same manner as FIG. 3 and FIG. 4 in the FIG. 1 embodiment, and the prism Pr is formed such that the height H is changed in the same manner as FIG. 6 and FIG. 7 in the FIG. 5 embodiment, however; it is needless to say that the luminance distribution can be flexibly controlled by arbitrarily changing the height H in at least any one of the axis L1 direction (axis L2 direction) and the longitudinal direction of the prism Pr.

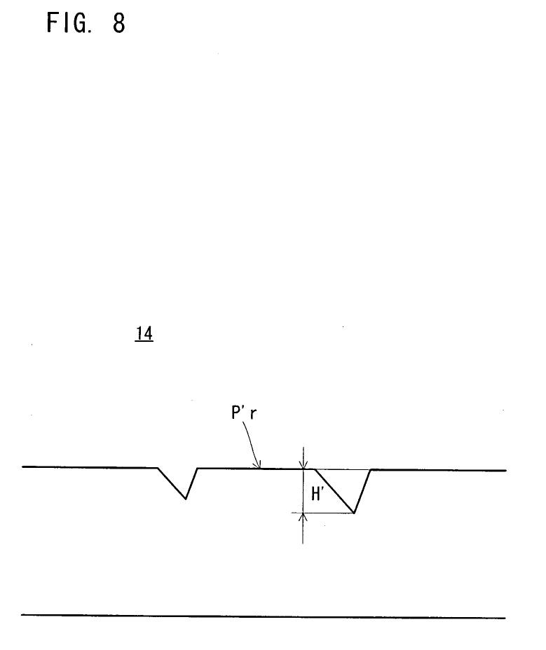

In addition, although a cross-section of each prism Pr in a longitudinal direction is formed in a mountain-shape as shown in FIG. 2, a cross-section of the prism Pr is not limited to the above-described one. That is, in a case the above-described decrease of the contrast is not taken into account, a prism Pr′ having a V-shaped cross-section in the longitudinal direction may be formed on the upper surface as shown in FIG. 8. At this time also, the heights H′ are changed in the same manner as FIG. 3 and FIG. 4 or FIG. 6 and FIG. 7.

In addition, although a description is made utilizing a front light type surface light source device in this embodiment, it is needless to say that the present invention can be applied to a backlight type surface light source device.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A light guide plate, comprising:
a corner portion formed by a first side surface and a second side surface; and
one main surface for emitting a light beam irradiated from said corner portion, wherein said one main surface is formed with a prism extending in circular arc form with rendering said corner portion as a center so as to connect said first side surface and said second side surface.

2. A light guide plate according to claim 1, wherein a height of said prism is changed in a longitudinal direction.

3. A light guide plate according to claim 2, wherein the height of said prism is made the lowest at an intersection with a central axis of the light beam irradiated from said corner portion.

4. A light guide plate according to claim 1, wherein said prism exists in plurality, and the heights of respective prisms are different from each other in a direction being away from said corner portion.

5. A light guide plate according to claim 4, wherein the heights of the respective prisms become higher with being away from said corner portion.

6. A surface light source device provided with a light guide plate according to any one of claims 1 to 5.
